(19) United States
(12) Patent Application Publication
(10) Pub. No.: US 2026/0266455 A1
(43) Pub. Date: Sep. 10, 2026

(54) STEAM GENERATION SYSTEM

(71) Applicant: HYDRAM RESEARCH, Reykjavik (IS)

(72) Inventor: Lydur THORGEIRSSON, Reykjavik (IS)

(21) Appl. No.: 19/165,751

(22) PCT Filed: Mar. 15, 2024
(86) PCT No.: PCT/IB2024/052557

§ 371 Date: Sep. 16, 2025

Related U.S. Application Data
(60) Provisional application No. 63/532,756, filed on Aug. 15, 2023.
(60) Provisional application No. 63/591,880, filed on Oct. 20, 2023.

(30) Foreign Application Priority Data
Mar. 17, 2023 (EP) 23020140.2

(51) Int. Cl. F22B 3/04; F22B 1/28; F22B 37/60

(52) U.S. Cl. CPC F22B 3/04; F22B 1/28; F22B 37/60

(57) ABSTRACT

A method and system for generating vapor or steam are provided, the system including a conduit for receiving a flowing liquid, an initiation valve for closing the conduit, and a gas section of the conduit downstream from the initiation valve. The initiation valve may be arranged to abruptly close and leave a moving liquid column in the gas section, such that the liquid column moves away from the initiation valve and generates a low pressure between the initiation valve and the liquid column that partially vaporizes the liquid column into a vapor. The system may include an extraction valve for collecting the vapor and a heating element for heating the vapor in the gas section.

### TECHNICAL FIELD

The disclosure relates generally to the generation of heated and pressurized steam and/or gas. More specifically, the present disclosure relates to devices, systems, and methods for using kinetic and/or potential energy of a liquid and/or the liquid's thermal energy content in the generation of steam and devices, systems, and methods for the heating, collection, and/or use of the generated steam.

### BACKGROUND

Mankind has innovatively harnessed hydropower for thousands of years. For example, development of the water wheel brought significant advances in milling, manufacturing of paper, hammering of iron and production of textiles.

Traditional hydroelectric power generation using rotating turbines and generators is considered one of the best ways to create electricity due to its minimal operating costs, no burning of hydrocarbons and because of its capability to store and manage energy in water reservoirs. Drawbacks to traditional hydroelectric power, however, include high initial installation costs compared to other types of power generation and its reliance on sensitive and interconnected equipment vulnerable to various threats.

Thermal transfer during evaporation of liquids has been used as a means for cooling habitats for centuries and more recently in refrigeration, heat pumps and evaporative cooling mechanisms. It is furthermore one of the fundamental ways the human body regulates its temperature.

Steam is the interim medium of power world-wide and is used in industry, heating and power production. Many modern industrial processes use vast amounts of steam. For example, hot pressurized steam is a mainstay in the paper and pulp industries, in chemical manufacturing industries, in petroleum refining plants, in textile industries, in the food industry, etc. Steam also plays a significant role in electricity production, mainly in converting hydrocarbons such as coal and gas into electricity and in nuclear power plants. Geothermal steam is also used directly in power production and heating. Steam furthermore is widely generated and used for central heating. It is likely a reasonable estimate that over half of extracted hydrocarbons are burned to create steam. The steam is subsequently used in various power intensive industrial processes, for space heating as well as generating the lion's share of the world's electricity (coal & gas).

There is always a need for improvements, such as for an alternative method of steam generation that's both economical and does not rely on hydrocarbon combustion or externally supplied electricity.

### SUMMARY

The embodiments disclosed herein are directed to providing improved vapor or steam generating systems and methods that enable an advantage of efficient vapor or steam production with reduced energy costs. The embodiments may be employed to generate vapor or steam for direct use in heating and/or industrial processes, or to generate vapor or steam for use in generating electricity.

In simple “layman's terms” one embodiment of the disclosure could be described to generate steam in an “inverted manner”. Instead of heating water to its boiling point and beyond, the system repeatedly turns few drops of liquid into vapor with an abrupt pressure drop. The sudden reduction in pressure is generated by interrupting a fast-flowing column of liquid, such as by closing an initiation valve in a conduit, to cause a liquid column to form that continues to move away from the interruption. At a tail end of said liquid column, a few drops of liquid expand into a low-pressure cold steam in a process that may be referred to as “water-hammer induced cavitation”, “cold boiling” or simply “evaporation”. When the system has generated the steam, the system may energize or heat the cold steam in order to preserve it and prevent it from being turned into condensate. The system may then pressurize the steam by reducing its volume, a process which if done rapidly may further increase the steam's temperature. When the steam reaches a certain pressure and/or temperature, the steam may be collected and separated from the liquid column, such as by a steam extraction valve momentarily opening to extract the steam. After extraction of the steam, the process may be repeated. For example, an initiation valve may re-open, allowing the liquid to accelerate again so that the process may be repeated.

In water-based systems according to some embodiments, one such steam generation cycle can take around 3 seconds for one example of what may be considered a small system and more than 15 seconds for a larger system with over thirty-meter head height producing well in excess of 100 kW equivalent of steam.

A system for generating steam or vapor is provided comprising an inlet section of a conduit connected to a supply of liquid, a gas section of the conduit connected to the inlet section, and an initiation valve provided between the inlet section and the gas section. The initiation valve may be configured to abruptly close and form a moving liquid column in the gas section, such that a momentum of the moving liquid column causes the moving liquid to continue moving away from the initiation valve and generate a low pressure area in the liquid column close to the initiation valve, vaporizing and expanding a small amount of the liquid.

The system may furthermore comprise means of heating the vapor generated by the system. A vapor heating mechanism may be powered by an external power source or by a mechanism in the system which generates power using the kinetic energy from the moving liquid.

The system may include a vapor extraction mechanism configured to allow vapor to be ejected or extracted from the system, for example after pressurization. The vapor extraction mechanism may further be configured to prevent liquid from exiting the system and/or to prevent vapor from reentering the system.

The initiation valve may optionally but preferably be elevated compared to a lower part of the system, for example so that a weight of the elevated liquid's mass may contribute positively to creating the low pressures required to vaporize the liquid and create more vapor.

The initiation valve may comprise a valve disk and a power generation mechanism. The valve disk may optionally but preferably define a curved shape configured so that, when the valve abruptly closes, the disk deflects the fast-moving upper column of water into a power generation mechanism. Such a power generation mechanism may be comprised of a slug element that may be provided at, or move to, a starting position when the initiation valve is open. When the initiation valve is closed, the shape of the valve disk may be configured to direct the liquid above the initiation valve in a direction of the slug element, for example forcing the slug to accelerate towards and collide with a stopper of the power generation mechanism. In such a power generation mechanism having a slug element, the power generation mechanism may generate electricity by deforming piezoelectric material using a collision of the stopper and the slug and/or by use of a linear accelerator. In some embodiments, for example where several sharp voltage pulses may be required for a vapor heating mechanism, slug elements and/or stoppers of slightly different mass may be arranged in series for providing a burst of several collisions in succession.

In some embodiments, a liquid in the system may be pre-heated or otherwise provided to the system at an elevated temperature, such as for increasing the system's efficiency and/or increasing production of vapor. Higher liquid temperatures may advantageously increase vaporization pressure, allowing for an increased mass of vapor produced in each cycle of the system.

Energy for a vapor heating mechanism may be generated using a power generation mechanism configured to convert a kinetic energy of the liquid or pressure fluctuations in proximity to the initiation valve to electrical energy. The power generation mechanism may use a conventional electrical generator, a linear actuator and/or a slug element configured to generate electricity by deforming piezoelectric material. The power generation mechanism may be configured to generate electricity directly from pressure fluctuations in the inlet section by lining or building the inlet section using piezoelectric materials. Energy required for a vapor heating mechanism may also or alternatively be sourced from an external power source.

A vapor heating mechanism according to the disclosure may comprise means of inducing, with high voltage and/or rapid changes in voltage, one or more ion waves, streamers, arcs and/or sparks through the vapor for heating the vapor. A vapor heating mechanism according to varying embodiments may be configured for providing microwaves, infrared, or other electromagnetic radiation wherein said electromagnetic radiation comprises a suitable frequency known to be absorbed by the newly generated vapor.

An initiation valve according to varying embodiments may further be configured to repeatedly open and close. The closing of the valve for generating vapor or steam, and the opening of the valve to allow the liquid to enter the gas section and join with or form the lower water column. The initiation valve may be designed to operate independently and/or with external assistance, such as to regulate a timing of each phase in the system's operation and/or to shut the system off.

Movement of a lower water column back towards the initiation valve and against the generated vapor may be used to compress, pressurize, heat, and/or eject the vapor. The lower water column may be accelerated by a pressure difference between its two ends. Such a pressure differential may be further augmented by increasing the pressure in the lower water column at a point between the end of the generated vapor and the far end of the lower water column. Such an increase may be achieved by providing a pressure mechanism connected to the conduit with the lower water column on a side further away from the initiation valve. A rapid compression phase of the vapor in the system may be an approximately isentropic process which may further heat the vapor or steam.

In systems with significant head-height from the initiation valve to the systems lowest point and/or systems requiring higher pressures and/or temperatures, the system may include a mechanism, connecting to the conduit with the lower water column at a side further away from the initiation valve and the generated vapor, which increases a liquid pressure of the lower liquid column during part or all of a compression phase of the vapor.

One embodiment of such a pressure increase mechanism may comprise a pressure container connected to the conduit with the lower water column. The pressure container may include a compressible medium or “cushion”, for example of air, which is compressed during pressurization. The pressure in the container can be increased during the initial acceleration phase of the system when the initiation valve is open and the liquid is accelerating and/or by connecting a pressure container directly to the liquid inlet and/or to a upstream high-pressure liquid vessel.

Alternatively, in systems where even higher pressure and heat may be required, the vapor or steam may be pressurized by re-opening the initiation valve during or just following the vapor generation process, allowing the liquid to enter the low-pressure area in the gas section where it may rapidly accelerate and pressurize the vapor further away from the initiation valve.

A method for generating steam or vapor is provided, the method comprising providing a flowing liquid to an inlet section of a conduit, the inlet section connected to a gas section of the conduit at an initiation valve, and abruptly closing the initiation valve to form a moving liquid column in the gas section, such that the liquid column in the gas section moves away from the initiation valve, lowering the pressure in the liquid column in the area next to the valve to a point where a portion of the liquid column is vaporized.

The system may alternatively or additionally be used to separate and remove gases and/or fluids from a main working liquid, for example gases and/or fluids having higher vaporization pressures than the main working liquid. In one method of gas separation, the vapor or steam generation process may be interrupted or paused in order to delay the pressurization of the vapor or steam. In some embodiments, this may be performed using a delay valve placed in the lower liquid column at a distance from an intersection of a vaporized gas and the lower liquid column. The delay valve may be configured to close momentarily after vaporization, such as for allowing other gases in the lower liquid column to expand, float up into the gas section and replace the vaporized gas partly or fully. When this fractional distillation process has been concluded, the delay valve may subsequently open to allow the lower liquid column to traverse back toward the initiation valve, such as to pressurize, heat and eject a resulting gas mixture.

The system may include a gas extraction valve located near one end of the gas section, for example where a pressurized gas may be located after it is compressed. The gas extraction valve may be configured to eject a vapor or steam at a determined pressure and/or temperature. The valve may furthermore be configured to both prevent the ejection of pressurized liquid out of the gas section and/or preventing already generated vapor or steam from re-entering the gas section.

This summary is provided to introduce a selection of concepts in a simplified form that are further described below in the detailed description. This summary is not intended to identify key features or essential features of the claimed subject matter, nor is it intended to be used as an indication of the scope of the claimed subject matter.

Additional features and advantages of the disclosure will be set forth in the description that follows, and in part will be obvious from the description, or may be learned by the practice of the disclosure. The features and advantages of the disclosure may be realized and obtained by means of the instruments and combinations particularly pointed out in the appended claims. These and other features of the present disclosure will become more fully apparent from the following description and appended claims or may be learned by the practice of the disclosure as set forth hereinafter.

### BRIEF DESCRIPTION OF THE DRAWINGS

These and other features, aspects, and advantages of the present disclosure will become better understood regarding the following description, appended claims, and accompanying drawings. It is appreciated that these drawings depict only some typical embodiments of the disclosure and are not therefore to be considered to be limiting of its scope. The disclosure will be described and explained with additional specificity and detail through the use of the accompanying drawings in which:

FIG. 1 includes an illustration of a system for generating steam according to an embodiment of the disclosure.

FIG. 2 includes an illustration of a method for generating steam according to an embodiment of the disclosure.

FIG. 3 includes an illustration of a system for generating steam during a liquid acceleration phase according to an embodiment of the disclosure.

FIG. 4 includes an illustration of a system for generating steam during a vaporization phase according to an embodiment of the disclosure.

FIG. 5 includes an illustration of a system for generating steam during a heating phase according to an embodiment of the disclosure.

FIG. 6 includes an illustration of a system for generating steam during a compression phase according to an embodiment of the disclosure.

FIG. 7 includes an illustration of a system for generating steam during an extraction phase according to an embodiment of the disclosure.

FIG. 8 includes an illustration of a method for generating steam according to an embodiment of the disclosure.

FIG. 9 includes an illustration of a system for generating steam having an energy generation mechanism at an initiation valve according to an embodiment of the disclosure.

FIG. 10 includes an illustration of a system for generating steam having an energy generation mechanism at an initiation valve according to an embodiment of the disclosure.

FIG. 11(a) includes an illustration of a system for generating steam having a heating means according to an embodiment of the disclosure.

FIG. 11(b) includes an illustration of a system for generating steam having a heating means according to an embodiment of the disclosure.

FIG. 11(c) includes an illustration of a system for generating steam having a heating means according to an embodiment of the disclosure.

FIG. 12 includes an illustration of a system for generating steam having a vapor extraction mechanism according to an embodiment of the disclosure.

FIG. 13 includes an illustration of a system for generating steam having a pressurization mechanism according to an embodiment of the disclosure.

FIG. 14 includes an illustration of a system for generating steam according to an embodiment of the disclosure.

FIG. 15 includes an illustration of a system for generating steam according to an embodiment of the disclosure.

FIG. 16 includes an illustration of a system for generating steam according to an embodiment of the disclosure.

FIG. 17 includes an illustration of a system for generating steam according to an embodiment of the disclosure.

The drawing figures are not necessarily drawn to scale, but instead are drawn to provide a better understanding of the components, and are not intended to be limiting in scope, but to provide exemplary illustrations.

### DETAILED DESCRIPTION

### Overview

A better understanding of different embodiments of the disclosure may be had from the following description read with the accompanying drawings in which like reference characters refer to like elements.

While the disclosure is susceptible to various modifications and alternative constructions, certain illustrative embodiments are in the drawings and are described below. It should be understood, however, there is no intention to limit the disclosure to the specific embodiments disclosed, but on the contrary, the intention covers all modifications, alternative constructions, combinations, and equivalents falling within the spirit and scope of the disclosure.

It will be understood that unless a term is expressly defined in this application to possess a described meaning, there is no intent to limit the meaning of such term, either expressly or indirectly, beyond its plain or ordinary meaning.

As used herein, including in the claims, singular forms of terms are to be construed as also including the plural form and vice versa, unless the context indicates otherwise. Thus, it should be noted that as used herein, the singular forms “a,” “an,” and “the” include plural references unless the context clearly dictates otherwise.

Throughout the description and claims, the terms “comprise”, “including”, “having”, and “contain” and their variations should be understood as meaning “including but not limited to”, and are not intended to exclude other components.

The present disclosure also covers the exact terms, features, values and ranges etc. in case these terms, features, values and ranges etc. are used in conjunction with terms such as about, around, generally, substantially, essentially, at least etc. (i.e., “about 3” shall also cover exactly 3 or “substantially constant” shall also cover exactly constant).

The term “at least one” should be understood as meaning “one or more”, and therefore includes both embodiments that include one or multiple components. Furthermore, dependent claims that refer to independent claims that describe features with “at least one” have the same meaning, both when the feature is referred to as “the” and “the at least one”.

Reference throughout this specification to “one embodiment” or “an embodiment” or “some embodiments” or “varying embodiments” or the like, means that a particular feature, structure or characteristic described in connection with the embodiment is included in at least one embodiment of the present disclosure. Thus, appearances of the phrases “one embodiment” or “an embodiment” or “some embodiments” or “varying embodiments” or the like in various places throughout this specification are not necessarily all referring to the same embodiment but may. Furthermore, the particular features, structures or characteristics may be combined in any suitable manner, as would be apparent to one of ordinary skill in the art from this disclosure, in one or more embodiments.

Furthermore, while some embodiments described herein include some, but not other features included in other embodiments, combinations of features of different embodiments are meant to be within the scope of the disclosure, and form different embodiments, as would be understood by those in the art. All the features and/or steps disclosed in the specification can be combined in any combination, except for combinations where at least some of the features and/or steps are mutually exclusive. Preferred features of the disclosure are applicable to all aspects of the disclosure and may be used in any combination. For example, in the following claims, any of the claimed embodiments can be used in any combination.

Similarly, it should be appreciated that in the description of exemplary embodiments of the disclosure, various features of the disclosure are sometimes grouped together in a single embodiment, figure, or description thereof for the purpose of streamlining the disclosure and aiding in the understanding of one or more of the various inventive aspects. This method of disclosure, however, is not to be interpreted as reflecting an intention that the embodiments require more features than are expressly recited in each claim. Rather, as the following claims reflect, inventive aspects lie in less than all features of a single foregoing disclosed embodiment. Thus, the claims following the detailed description are hereby expressly incorporated into this detailed description, with each claim standing on its own as a separate embodiment of this disclosure.

It will be appreciated that variations to the disclosed embodiments of the invention can be made while still falling within the scope of the disclosure. Features disclosed in the specification, unless stated otherwise, can be replaced by alternative features serving the same, equivalent or similar purpose. Thus, unless stated otherwise, each feature disclosed represents one example of a generic series of equivalent or similar features.

Use of exemplary language, such as “for instance”, “such as”, “for example” and the like, is merely intended to better illustrate the invention and does not indicate a limitation on the scope of the disclosure unless so claimed. Any steps described in the specification may be performed in any order or simultaneously unless the context clearly indicates otherwise.

As used herein, the terms “gas,” “steam,” and “vapor” are generally intended to mean the same and to be understood by their common dictionary definitions. That is, the terms “gas,” “steam,” and “vapor” broadly include water and/or liquids in a gaseous instead of liquid or solid form. Examples of other liquids that may be employed and/or vaporized according to the disclosed embodiments may include one or more of bromine, chloroform, ethyl acetate, acetone, etc., although the disclosure is not limited thereto. As such, “gas,” “steam,” and “vapor” according to the disclosure may be created from water and/or similar substances/liquids at a respective combination of pressure and temperature conditions, for example as evident by a phase diagram for water, such as through evaporation, cavitation, boiling, vaporization, and/or related mechanisms. It will be appreciated that the systems, devices and methods of the present disclosure may be configured to produce heated gas or gas hotter than the working liquid.

Similarly, while they may be referenced as “water vapor,” “steam” or the like for exemplary purposes, the use of these terms in the disclosure contemplates liquids and fluids of various character and composition. For example, liquids used in the described embodiments may include water obtainable from a variety of different sources, both natural and man-made, with corresponding vapor or steam generated therefrom. Further, additives may be included or provided in the liquid for reducing conductivity and/or adjusting other properties. Likewise, the liquid may be pretreated for configuring similar properties.

The terms conduit, pipe or tube may be used interchangeably herein and refer to a substantially rigid, hollow structure allowing liquid to flow through said hollow structure. Furthermore, the substantially rigid hollow structure is not limited to any specific geometrical shape (cross-section) and may comprise a layered structure (i.e., having layered walls), wherein the material selection and thickness of different layers is selected to obtain desired physical properties of each layer and the overall structure.

Similarly, while valves are described herein in various positions and/or configurations, it should be understood that suitable valves may be of varying types. In particular, although drawn in the figures as butterfly valves, clack valves, or one-way valves, other valves may be considered for performing the specified operation as may be suitable for the function, such as gate valves or other types of valves.

Moreover, the term “liquid column” as used herein, refers to an expanse or a body of liquid arranged or stretched in any orientation (horizontal, angled, curved or vertical) between two components, wherein the two components may comprise space of near-vacuum, gas, vapor or air, such as a liquid column arranged between a low-pressure space of gas/vapor and for example ambient air. In some embodiments, the liquid column may be defined by a valve acting as an end component thereof. Depending on the context, a liquid column may be at rest (stationary) or may be moving as a single component.

### Various Embodiments and Components for Use Therewith

Embodiments of the present disclosure provide novel devices, systems and methods for the production of gas from a liquid using kinetic energy and/or the weight of the liquid and/or the thermal energy content of the liquid. In some embodiments, the devices, systems and methods may be provided for the production of heated and/or pressurized gas from the liquid using the kinetic energy and/or the weight of the liquid and/or the thermal energy of the liquid. For example, devices, systems and methods of the disclosure may abruptly stop a flow of liquid in order to convert the kinetic energy and/or the weight of the elevated liquid and/or the liquid's thermal energy content to the energy intensive process of vaporizing a portion of the liquid into steam. Furthermore, the disclosed embodiments may be configured to heat, compress, eject, collect, and/or otherwise employ the resulting steam for heating, industrial purposes and, in some embodiments, to generate and harness electrical energy.

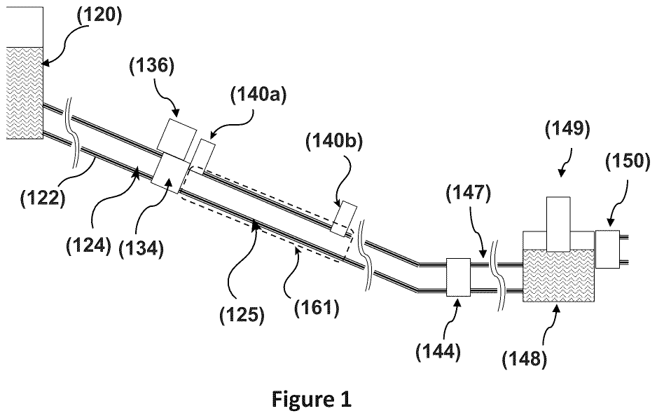

As an illustrative example of the foregoing, steam generation systems disclosed herein may include a conduit provided in the form of a pipe (122), including an initiation valve (134) provided at an inlet section (124) of the pipe (122), such as shown in the illustrated embodiment of FIG. 1. In varying embodiments, an energy generation mechanism (136) may be provided in the system, for example in front of the initiation valve (134) or a valve disk thereof. Following the initiation valve (134), the system may comprise a gas section (125) where a liquid may be vaporized. The gas section (125) may include means for heating the vapor for example in the form of antennas/electrodes (161) as shown in FIG. 1. A vapor extraction mechanism or extraction valve (140a) and/or (140b) may be provided at one or both ends of the gas section (125). In some embodiments, a downstream valve (144) may be provided following the gas section (125) and may, for example, be configured for controlling a compression phase of the vapor. As seen in the depicted embodiment of FIG. 1, a horizontal section (147) may be provided in the system before a liquid trap (148). A liquid trap (148) may be provided or otherwise configured for preserving an interface between the working liquid and the vapor by preventing air or the like from entering the horizontal section (147) and/or the gas section (125) during the system's compression phase, which may involve the liquid traversing in the direction of the initiation valve. For example, a liquid trap (148) may comprise a tank or other container as illustrated in the embodiment of FIG. 1 and/or, in some embodiments, may be provided as a section having an increased elevation or the like. A pressurization system (149) may be provided near an end of the system, for example configured to assist with the compression phase in the system. A lower part of the system may include a terminal valve (150), for example at an end of the system.

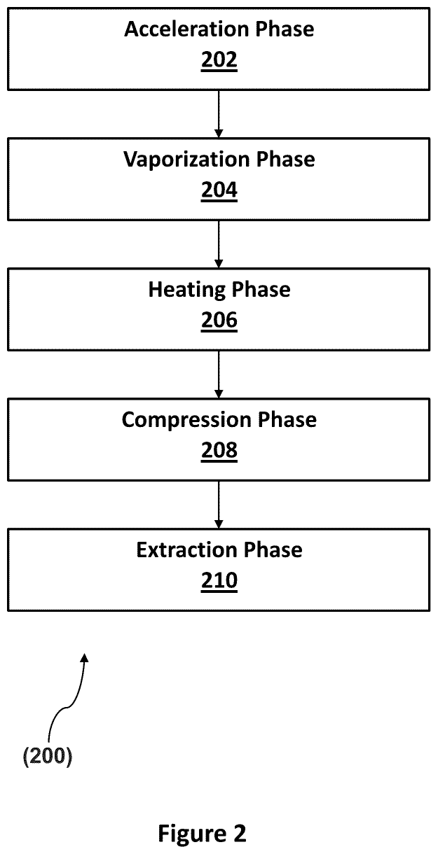

An illustrative example of a method (200) for generating vapor or steam from a liquid is described with respect to FIG. 2, such as may be performed with a system according to the embodiment of FIG. 1. As seen in FIG. 2, the method (200) may comprise an acceleration phase (202), a vaporization phase (204), a heating phase (206), a compression phase (208), and an extraction phase (210). In an acceleration phase (202) a flowing liquid may be provided to an inlet section of a conduit, the inlet section connected to a gas section of the conduit at an initiation valve. The flowing liquid may accelerate through the inlet section, the open initiation valve and the gas section until the liquid reaches a predetermined velocity. In a vaporization phase (204) the initiation valve may be abruptly closed, sealing the gas section from the inlet section and causing a liquid column to form from the flowing liquid in the gas section, such that the liquid column moves away from the initiation valve and generates a low pressure in the gas section that partially vaporizes the liquid column into a vapor. In the vaporization phase (204) the liquid column may decelerate in response to the low pressure in the gas section. In a heating phase (206) the vapor in the gas section may be heated using a heating means, such that the vapor persists as a gas without condensing to a liquid form and rejoining the liquid column. The heating of the vapor in the heating phase (206) may be described as a “flash-heating”, a rapid heating of the vapor. The heating phase (206) may start when the vaporization phase (204) has ended and may coincide with an initial or entire duration of a compression phase (208). In a compression phase (208) the liquid column moves back towards the initiation valve using kinetic and potential energy of the system, which compresses the vapor. This compression of the vapor further heats and pressurizes the vapor. In various embodiments, the heat of compression added to the vapor during the compression phase (208) may be significantly greater than the heat added to the vapor in the heating phase (206). Following the compression phase (208), when the gas has been sufficiently pressurized and heated, an extraction phase (210) may begin. In the extraction phase (210) the liquid column continues its travel toward the initiation valve, reducing available volume for the vapor which allows the hot and pressurized vapor to be extracted from the gas section of the conduit, for example using an extraction valve. Notably, the method (200) of FIG. 2 may be repeated, such that the method (200) may represent a cycle of a repeating process.

Various phases of the method (200) may be further described in greater detail with respect to features or elements of the illustrated embodiments of corresponding systems below, with reference to the drawings of the disclosure.

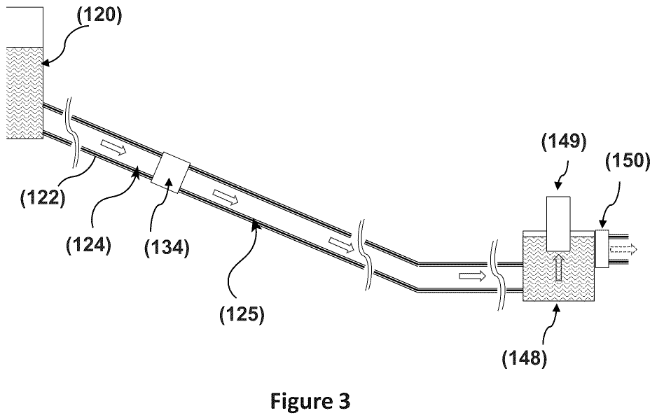

As illustrated in FIG. 3, during a liquid acceleration phase, a liquid may flow from a liquid source (120) and/or the inlet section (124) through the initiation valve (134) and into the gas section (125) which during this stage may be full of said liquid. The liquid may be accelerated or otherwise flow, for example, in response to gravitational force and/or pressure differential. During the liquid acceleration phase pressure may be allowed to build up in the pressurization system (149), such as for use in a later phase. In some embodiments of the system, the liquid may be allowed to exit via a terminal valve (150).

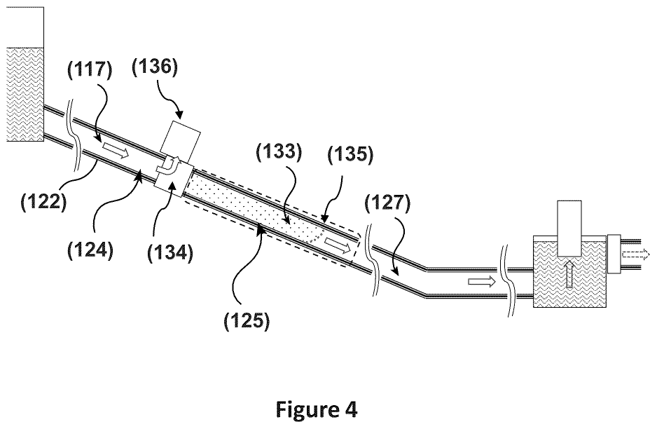

As illustrated in FIG. 4, when predetermined conditions are fulfilled, such as the liquid in the pipe (122) reaching a predetermined velocity, the initiation valve (134) may be configured to abruptly close, splitting the flowing liquid into two separated liquid columns. A lower liquid column (127), starting in the gas section (125) of the pipe (122) and initially moving away from the closed initiation valve (134) and an upper liquid column (117) in the inlet section (124).

Herein, the term “abruptly” refers to a sufficiently rapid process relative to a flow rate such that abruptly stopping the flow of liquid will cause a pressure shockwave (also known as the water hammer effect) both in front and behind the initiation valve (134). As such, with the initiation valve (134) having been closed, the lower liquid column (127) in the gas section (125) of the pipe (122) continues, due to its momentum and/or weight, to traverse downstream said gas section (125) while rapidly decelerating. As the lower liquid column (127) travels downstream, low-pressure (or near-vacuum) conditions form behind or upstream of the lower liquid column (127), such as between the lower liquid column (127) and the initiation valve (134). This causes a hydrostatic pressure of said liquid of the lower liquid column (127) to reduce below a liquid vapor pressure at an interface (135) between the lower liquid column (127) and the low-pressure region forming between the lower liquid column (127) and the initiation valve (134), forcing evaporation and/or cavitation from said lower liquid column (127) to form evaporated particles (133) (herein, referred to as gas or vapor or steam) in the gas section (125) of the pipe (122). In certain embodiments, if the liquid is a mix of different liquids, a liquid with a highest vapor pressure may vaporize first allowing for separation of the different liquids.

Following the abrupt closing of the initiation valve (134), the kinetic and pressure-wave energy of the upper liquid column (117) may be harnessed by the system. In some embodiments, such as illustrated in the embodiment of FIG. 4, the upper liquid column (117) may be diverted, such as by the initiation valve, to an energy generation mechanism (136).

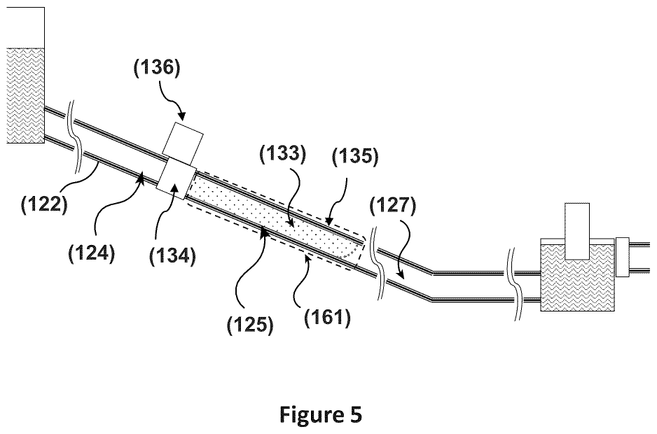

In varying embodiments, and as illustrated in FIG. 5, the formed vapor (133) may be promptly energized by the system. This energization of the formed vapor (133) may preferably commence as soon as the vapor has been formed and the lower water column has come to a halt. By increasing the vapor's enthalpy, its pressure and/or temperature should at the minimum be increased and maintained sufficiently for it not to condense during the vapor's compression phase and preferably so that the compression process becomes approximately isentropic, elevating the vapor's temperature and pressure.

In many embodiments, an amount of energy required to heat the vapor is trivial compared to the energy required for the vaporization and rapid compression, a process that if approximately isentropic further heats and pressurizes the vapor. The required heating energy can be sourced from outside the system (not shown) and/or from sources within the system itself, such as from an energy generation mechanism (136).

In varying embodiments, the formed vapor (133) may be energized using one or more heating means provided at the gas section (125). The heating means may include devices for conducting current through the vapor, devices for heating the vapor using electromagnetic waves, and/or devices for applying heat to the gas section generally (e.g., inductive heating elements). For example, the vapor (133) may be heated using an electrically induced fast ion wave, ion wave, plasma, spark or short duration arc generated by antennas/electrodes (161) in, around or in proximity to the gas section. The vapor (133) may also or alternatively be energized using a beam of electromagnetic energy, at frequencies selected for maximum absorption by the vapor, including light generated by a laser, microwaves and/or related electromagnetic radiation. As such, the heating may be performed using a laser and/or a magnetron, or related device, configured to emit electromagnetic radiation into the vapor in the gas section of the conduit Other ways to energize the vapor (133) may be employed, such as inductive heating, frictional heating, vibrational heating, heating using sound waves, and/or another heating means.

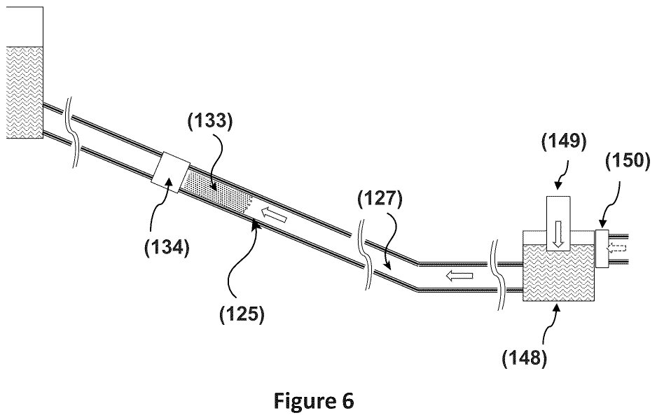

In varying embodiments, the system may be configured to rapidly pressurize the vapor following its heating phase. One method of doing so is depicted in FIG. 6 where the lower liquid column (127) is allowed to accelerate back into the gas section (125) toward the initiation valve (134). The lower liquid column may be accelerated by the low pressure of the vapor (133) and significantly higher pressure at a lower end of the lower liquid column, for example in the liquid trap (148). In some embodiments, a pressurization mechanism (149) may be provided to increase a pressure at the lower end of the lower liquid column (127). In some embodiments, the system may include a terminal valve section (150) that may open to allow atmospheric pressure to assist in the acceleration of the lower liquid column (127) back toward the initiation valve (134).

In preferred embodiments, a compression of the vapor (133) may be allowed to happen sufficiently rapidly for the process to become approximately isentropic, advantageously further increasing the temperature of the vapor (133).

When the vapor (133) has reached a predetermined state in terms of pressure, temperature and/or volume, a gas extraction valve (140a) may be configured to open, allowing the heated and/or pressurized gas to exit the gas section for storage and/or direct use. The gas extraction valve (140a) may be configured to prevent fluid from the lower liquid column (127) from following and mixing with the extracted pressurized vapor (133).

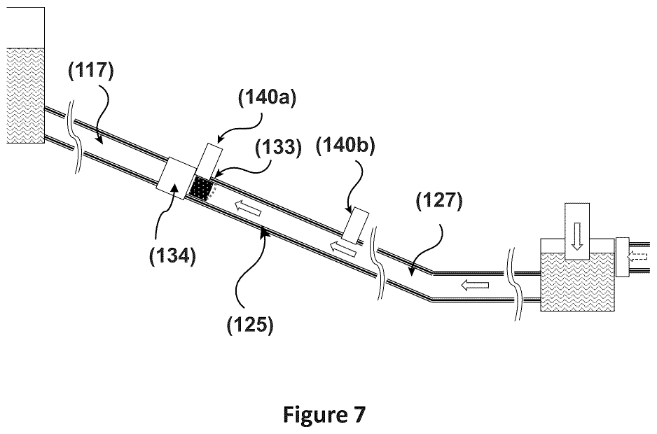

According to the embodiment of FIG. 7, the system may be configured such that the lower water column (127) assists in opening the initiation valve (134) when the vapor (133) has been extracted from the gas section, for example by contacting or impacting the initiation valve (134). Such an impact may be configured to open or reopen the initiation valve (134), allow the upper and lower liquid columns to join together and/or equalize a pressure on either side of the initiation valve (134).

According to varying embodiments, parameters of the system can be selected so that the lower liquid column (127) deaccelerates during a latter part of an extraction phase due to an increased elevation of the lower column (127) and/or increased pressure of the vapor (133) and/or reduced pressure from the pressurization system (149). Intentional design of systems that reduce the end velocity of the lower liquid column (127) during the compression phase may advantageously reduce energy loss from contact or collision at the closed initiation valve (134).

In another embodiment (not shown) the system may be configured to pressurize the vapor (133) by quickly reopening the initiation valve (134) during an end of the vaporization phase. In such an embodiment the upper water column (117) may quickly accelerate down into the gas section (125) and compress the heated vapor (133) by “sandwiching” it between the upper water column (117) and the lower water column (127). In such embodiments, the heated and pressurized vapor may be extracted thorough a gas extraction valve located where the upper (117) and lower (127) water columns would meet, contact, and/or re-unite.

Various valve types may serve as the system's initiation valve (134), including modified clack valves, butterfly valves, one-way ball-valves, gate valves and three-way-valves. The initiation valve (134) may be operated and/or partly assisted by an external control mechanism or can operate autonomously by the movement and/or pressures generated by the upper and lower liquid columns (117) and (127).

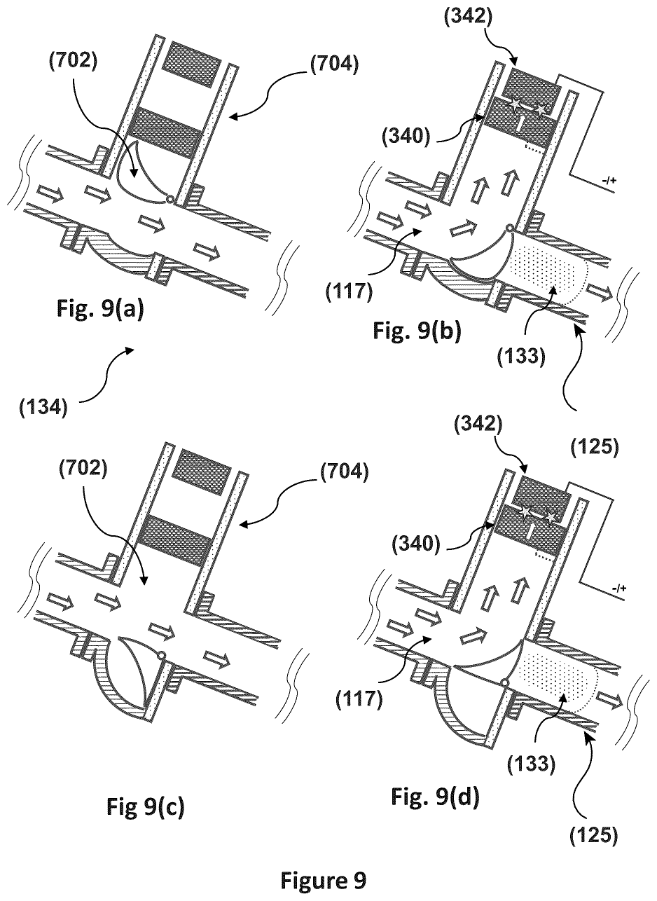

In one notable embodiment, depicted in FIG. 9, the initiation valve (134) may be integrated with a “slug” energy generation mechanism. According to the depicted embodiment of FIG. 9, an initiation valve (134) may comprise a hybrid between a clack valve and a three-way valve with a curved valve disk (702). When the initiation valve (134) is open, the valve disk (702) may be in an upright position as illustrated in sections (a) and (c) of FIG. 9, allowing the liquid to flow and accelerate through the initiation valve (134) and into the gas section (125). To keep the valve disk (702) in the upright position, the valve disk (702) may (i) be externally assisted and/or (ii) be buoyant in the liquid and/or (iii) be weighted or have weight offset around its turn-axis and/or (iv) be shaped so that the liquid lifts it at low velocities and pulls it down at higher velocities and/or (v) be shaped so that the liquid lifts it at high velocities

When the valve disk (702) abruptly closes, it may be configured to redirect the upper liquid column (117) to a face of a slug (340), such as for quickly accelerating the slug using the moving liquid. At the same time, the valve disk (702) closes the initiation valve (134) and stops the flow of liquid to the gas section, causing the pressure behind the initiation valve (134) to drop and generating a low pressure vapor (133) as discussed above.

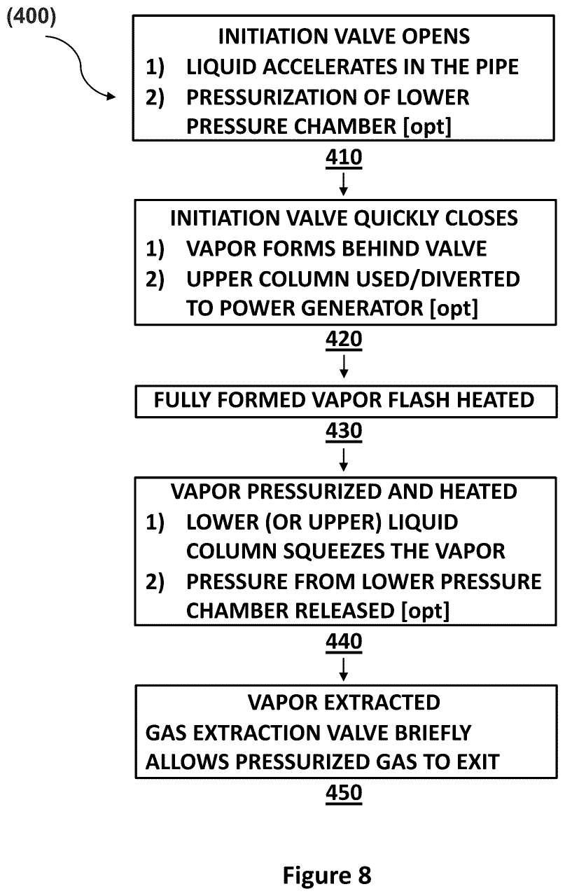

An embodiment of a method (400) for generating vapor or steam using kinetic energy of a liquid is illustrated in FIG. 8. The method may comprise accelerating a flowing liquid in a pipe (410) and closing an initiation valve (134) to form vapor (133) between the initiation valve (134) and a downstream liquid column (127). The method in the embodiment described in FIG. 8 generates the energy required for heating the vapor (133), heating the vapor (430), compressing and (further) pressurizing (and heating) the heated vapor (440), and removing the heated vapor from the pipe (450). Notably, while described as generating steam, the disclosed methods and systems could be used or otherwise adapted for boiling other liquids and/or extracting and/or separating one or more liquids from a base liquid, such as where the one or more liquids have a higher vapor pressure than the base liquid.

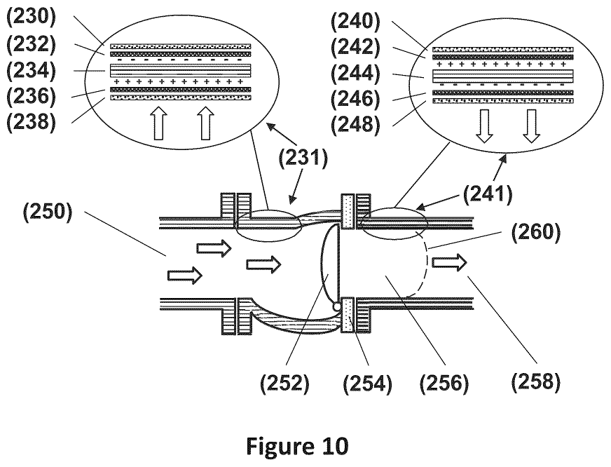

In the embodiment shown in FIG. 9, an energy generation mechanism is provided based on generating high voltage spikes by deforming piezo-electric material. This can be done by having a slug (340) accelerate through a slug cylinder (704) and hit a slug stopper (342). The impact of the violent collision deforms piezo-electric material, creating a high voltage spike. In sections (b) and (d) of FIG. 9, both the slug (340) and the slug stopper (342) include piezo electric material. The walls of the initiation valve (134) and/or the slug cylinder (704) and/or the valve disk (702) may also include piezo-electric material, for example as shown in FIG. 10. The high voltage pulse generated by the energy generation mechanism can be used for the vapor heating mechanism in the gas section (125).

A length of the slug cylinder (704) may furthermore be configured such that the impact and high voltage pulse coincide with the moment when the vapor (133) has been generated.

For some systems, several slugs (340) and stoppers (342) may be provided, in some examples having slightly different weights, and may be arranged to generate several high-voltage pulses in quick succession. In other embodiments (not shown), the slug cylinder (704) may harness the movement of the slug (340) to generate electricity in the same manner as a magnetic linear generator. The electrical energy generated could be stored in a capacitor and be released for energizing the vapor when it has been fully formed, or at another predetermined time. The slug may be returned to its original position due to being weighted, magnetized and/or springed (tensioned).

Embodiments of the current disclosure advantageously enable the very efficient creation of steam or vapor by using the kinetic energy and/or weight of a moving liquid to generate evaporative conditions by means of abrupt volume expansion. Although bringing a liquid through the liquid-gas barrier is the most energy intensive part of boiling, the kinetic and/or potential energy of the working liquid isn't lost when the cold vapor has been generated. Instead, it is stored in the tension generated during evaporation. According to the disclosed embodiments, this pressure tension energy may subsequently be used to pressurize and further heat the vapor.

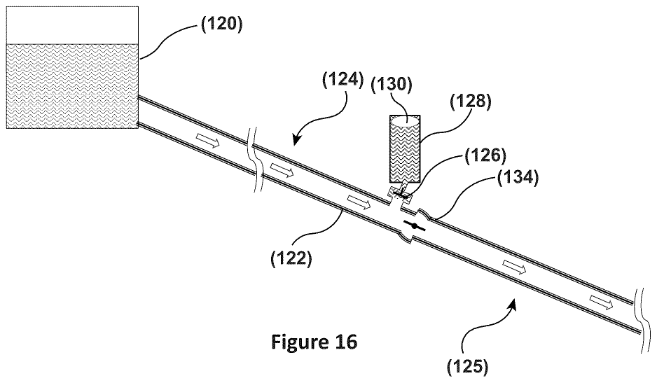

In varying embodiments, such as depicted in FIG. 16, a relief valve (126) may be included in the system, with or without a slug (340) as described in other embodiments. Likewise, while described as a slug (340), the slug (340) may be replaced with another weighted, magnetized, and/or springed (tensioned) actuator element, and/or a linear generator or motor which returns to its original position after having transformed the kinetic energy of the upper liquid column to electricity. Further, one or more slug (340) or related elements may be located in varying regions of the pipe, such as at one or more of the front of the initiation valve in parallel and/or in series, the back of the initiation valve, the front of the downstream valve, the back of the downstream valve, where pressure spikes occur during operation of the system etc.

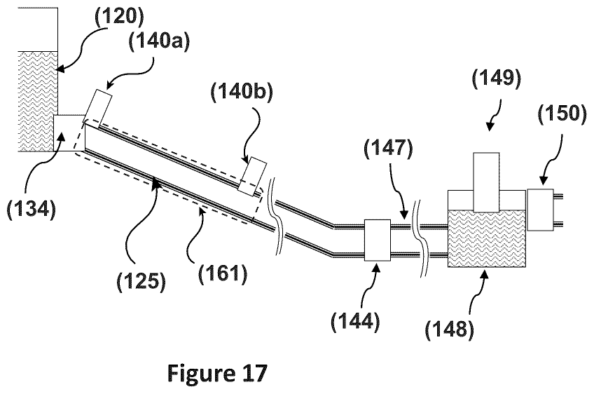

FIG. 17 illustrates an embodiment which uses externally sourced energy for the heating phase. In such embodiments the liquid source (120) and inlet section are unified. In such embodiments, an internal power generation mechanism to generate energy for the heating phase may not be required.

In some embodiments, a slug cylinder (704) above the slug (340) may be connected to the gas pressure vessel (143) storing the pressurized and heated vapor already generated by the system, such that operation of the slug may be automatically regulated by interaction between the pressure in the gas pressure vessel (143) and a top side of the slug (340) forming an airtight seal with the slug cylinder (704). For example, as the pressure in gas pressure vessel (143) increases, the slug's (340) impact with the slug stopper (342) will be reduced or prevented, reducing the energy generated and subsequently the energization of the newly generated vapor.

FIG. 10 depicts one embodiment of high voltage pulse generation using piezoelectric material to capture the kinetic energy and water-hammer induced pressure pulses generated when the initiation valve (134) is closed. The electrical pulse generated may be used to heat the gas by generating an ion wave, plasma, an electrical spark or a short duration arc in the vapor. In the embodiment of FIG. 10, a first piezoelectric portion (231) is provided upstream from the initiation valve (134), the initiation valve shown in this illustrated embodiment as a clack valve (252), and a second piezoelectric portion (241) is provided downstream from the clack valve (252). In the illustrated embodiment, the first and the second piezoelectric portions (231), (241) are shown as comprising a portion of the pipe (122) in the inlet section (124) and in the gas section (125), respectively. When forming a portion of the pipe (122), the first and the second piezoelectric portions (231), (241) must be configured with sufficient strength and structural integrity to resist the large pressure fluctuations occurring in the system. For this purpose, the first and the second piezoelectric portions (231), (241) may be supported by other materials forming the pipe, and/or may only be provided on an interior surface of the pipe.

Each of the first and second piezoelectric portions (231), (241) may include a piezoelectric material layer (234), (244), e.g., provided between an outside electrically conducting layer (232), (242) and an inside electrically conducting layer (236), (246). While not always required, some embodiments may further include an outside insulating layer (230), (240) comprising an electrically insulating material and/or an inside insulating layer (238), (248) comprising an electrically insulating material. Notably, for some embodiments, the charge generated by the piezo electric material (244) in the gas section (125) may itself assist in generating the required voltage difference to energize the vapor.

In use, the first and second piezoelectric portions (231), (241) may harness rapid pressure changes upstream and downstream from the clack valve (252) when a flowing liquid (250) is abruptly stopped and/or redirected by the closing of an invitation valve (134). As such, with the clack valve (252) having been closed, as illustrated in FIG. 10, the lower liquid column (258) is formed in the gas section of the pipe. As the lower liquid column (258) continues to traverse downstream said gas section (125), low-pressure (or near-vacuum) conditions form behind or upstream of the liquid column (258), such as between the liquid column (258) and the clack valve (252). This causes a hydrostatic pressure of said liquid (258) to reduce below a liquid vapor pressure at an interface (260) or liquid-gas boundary between the liquid column (258) and the low-pressure vapor (256) forming between the liquid column (258) and the clack valve (252), forcing evaporation and/or cavitation from said liquid column (258) to form evaporated particles (256) or vapor in the gas section of the pipe. The low pressure area generated contributes to the deceleration of the lower liquid column (258) which eventually is halted, ending the system's vapor generation phase. Similarly, when the lower liquid column (258) traverses back up, hits and opens the valve disk (252) and rejoins the upper water column (258) pressure fluctuations occur that can be harvested.

At the same time, the rapidly dropping pressure behind the clack valve (252) in the gas section induces forces “pulling” the second piezoelectric portion (241) inward, such that an electrical potential is created between the outside and inside layer of the piezoelectric material (244) which is captured with conducting layers (242) and (246). On the upstream side of the clack valve, the flowing liquid (250) generates one or more high pressure pulse(s) when abruptly stopped and/or redirected by the clack valve (254), in what may be referred to as the water hammer effect. The pressure pulses may, in effect, repeatedly compress and decompress the first piezoelectric portion (231) (initially “push” outwards), such that an electric potential is created between the outside and inside layer of the piezoelectric material (234). An electrocoated surface of the material (234), that is conducting layers (232) and (236) may be employed to capture the generated surface charge and the electrical energy for it to be harnessed elsewhere in the system. The respective conducting layers of the first and second piezoelectric portions (231), (241) may then be connected to a heating mechanism or antennas/electrodes for energizing the vapor such as by generating an ion wave, plasma, spark or arc in the vapor (256) in the gas section (125) of the pipe (122).

Notably, while referenced as a “clack valve” in some examples for ease of understanding, the initiation valve of the embodiments may comprise a different type of valve, as discussed herein.

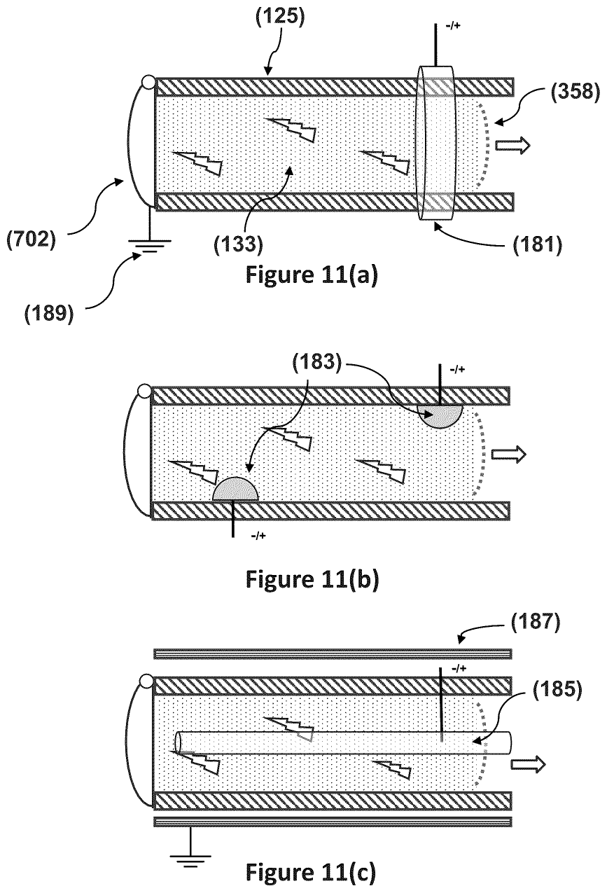

FIGS. 11(a), 11(b) and 11(c) depict various ways of energizing the vapor prior to its pressurization. In FIG. 11(a) a collar electrode (182) or antenna is provided near the end of the gas section (125). The collar antenna/electrode can be located inside or outside the pipe. When a high voltage electrical pulse with high frequency components is sent to the collar antenna/electrode (181), a wave may be sent through the low pressure vapor, energizing and heating the vapor. In FIG. 11(a), the valve disk (702) may be electrically conductive and grounded (189). According to FIG. 11(b), antenna/electrodes (183) may be provided in the gas section (182) to energize the vapor (133) by generating an ion wave and/or plasma and/or streamers, arc or spark. In FIG. 11(c), an antenna/electrode (185) may be provided inside the gas section (125) in a coaxial and/or a wave-guide manner to energize the vapor. Also depicted is a conductive shielding (187) that can furthermore be both refractive and thermally insulating in order to enhance the heating phase and slow enthalpy decrease of the vapor during the entire compression phase. The gas section and/or electronic equipment in contact with the fluid may be hydrophobically surface treated to prevent a thin layer of liquid or condensate from impeding emittance of electromagnetic waves through the vapor. Not depicted but contemplated for use with varying embodiments of the disclosure, are various other heating mechanisms, including the use of diffracted light generated by a laser, a pulse of infrared light, microwaves and/or sending electromagnetic frequencies into the gas section (125) that are selected to be optimally absorbed by the liquid vapor (133).

In some embodiments, inside walls of the gas section (125) may include refractive material to refract the electromagnetic energy emitted by the energized vapor back and forth, for example such that the energized vapor (133) is prevented from emitting its newly absorbed energy.

It should be emphasized that the energy required for the vapor heating mechanism is in most cases trivial in comparison to the energy required for generating the evaporative conditions and other steps of the process. In some embodiments therefore the energy for the vapor heating mechanism is externally sourced.

A vapor extraction mechanism or extraction valve (140) may be connected in or in the proximity of either end of the gas section (125) of the pipe (122). In some embodiments of the system the extraction valve (140a) may be provided in a vicinity of the initiation valve (134). For some embodiments, an extraction valve (140b) may be provided in a vicinity of an end of the gas section (125) away from the initiation valve.

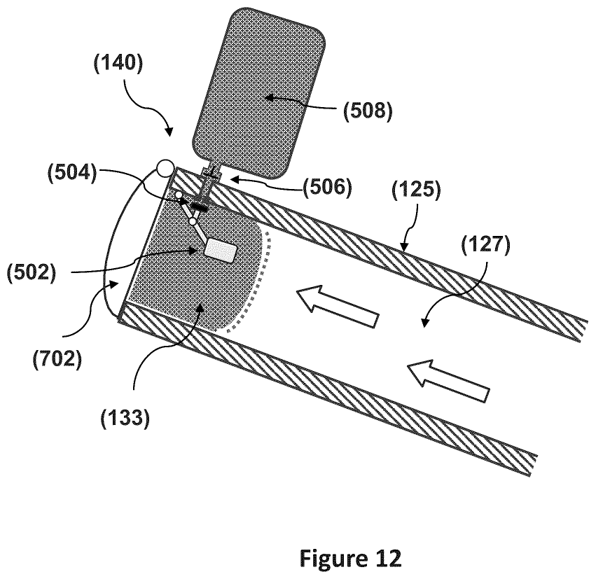

In the embodiment depicted in FIG. 12, a vapor extraction mechanism is provided adjacent to the initiation valve's disk (702). Further, the heated vapor (133) may be pressurized as the lower liquid column (127) rushes back in the direction of the initiation valve. In some embodiments of the system, pressure, temperature and/or liquid sensors may be provided in the gas section (125), for example adjacent to the initiation valve and for triggering an opening and closing of an extraction valve (not shown) to allow pressurized vapor to exit the system while preventing liquid from following it. In the simplified illustration of FIG. 12, an embodiment of the system includes a vapor extraction mechanism which combines buoyancy and a one-way valve. A float valve (504) may be opened when the lower water column (127) travels down the gas section, allowing the float (502) to drop. The float valve (504) may be connected to a one-way valve (506) configured to prevent anything from exiting the system unless a pressure in the gas section (125) is higher than a pressure above the one-way valve (506), for example in a pressurized gas storage chamber (508).

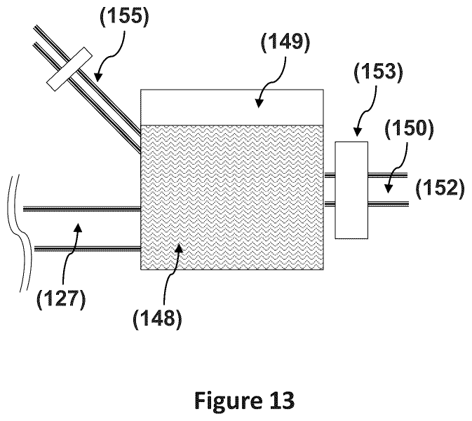

FIG. 13 depicts an embodiment of the system that uses a pressurization mechanism at or near an end of the lower water column. The pressurization system may also serve as the liquid trap (148). The pressurization system (149) may comprise a pocket of air and may be configured to be pressurized and to subsequently expand during a vapor compression phase, further assisting the lower water column (127) in traversing up the gas section and compressing the vapor. The pressurization system (149) may furthermore be a pump system assisting in accelerating the lower liquid column back toward the initiation valve.

In embodiments of the system, pressurization of the compressed pocket of air shown in the pressurization system (149) may be performed (a) during the liquid's acceleration phase toward the liquid trap and/or (b) via top connection pipe (155) to an elevated source of liquid such as the liquid source (120) and/or liquid inlet (124) as depicted in FIG. 13 and/or an upstream high-pressure liquid vessel (128) as depicted in FIG. 16.

In some embodiments of the system, the liquid trap may include an outlet (150) which may be elevated in comparison to the lower water column's (127) inlet to the liquid trap (148). The outlet may have a terminal valve (153) controlling flow out of the liquid trap (148) and the pressure in the pressurization system (149).

In some embodiments, a top connection pipe (155) may be connected to a heated low energy vapor close to a condensation line thereof. In such embodiments, the low energy vapor may be ejected into the pressurization system (149) and be configured to condense and/or collapse during the downward acceleration phase of the liquid toward the liquid trap (148). During this phase, the terminal valve (153) may be closed for the pressure in the liquid trap (148) to rapidly drop and assist with the acceleration of the liquid in its acceleration phase (202).

In some embodiments of the system, a downstream valve (144) may be provided between the gas section (125) and the liquid trap (148) as depicted in FIG. 1. The downstream valve can be set to momentarily close following the generation of the low pressure vapor (133) allowing gases and/or liquids mixed in the lower liquid column (127) to expand due to a low pressure between the vapor (133) and downstream valve (144). As the gases and/or liquids expand, they may float upwards and mix with the vapor (133), for example replacing it partly or fully. If the vapor (133) is fully replaced by the gases, a pressure in the gas section (125) will rise and become higher than the original vaporization pressure.

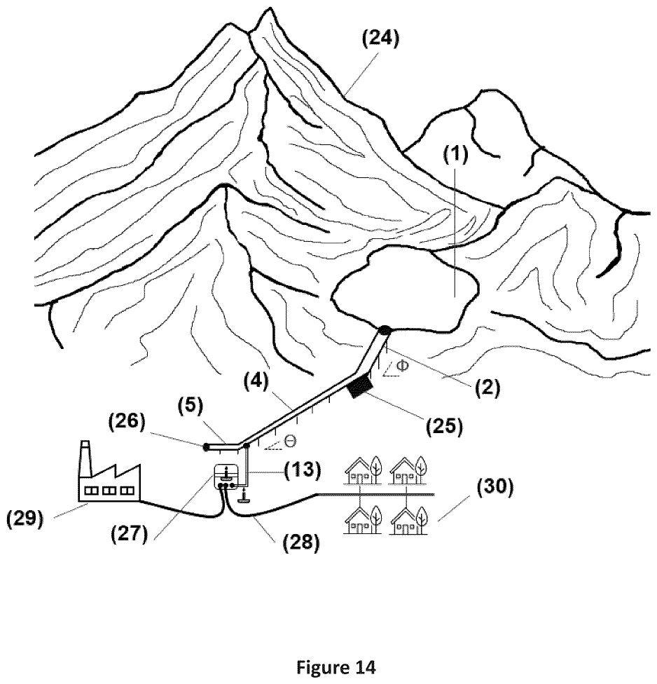

FIG. 14 illustrates a possible implementation of an embodiment of a system for generating vapor or steam according to various embodiments. For example, a system can be connected to a liquid supply (1), for example comprising water such as a lake, river, spring, or the like. The liquid may be located at a point of higher elevation than said system, such as in mountainous, hilly, or rough terrain (24). Systems according to this illustrated embodiment may be more common in temperate or tropical regions, as higher temperature working liquids may be used to increase steam production and system efficiency. When an inlet section (2) is connected to said liquid supply or water supply (1), liquid may begin to flow down-hill along said inlet section (2), gaining momentum due to the gravitational potential energy of the liquid being converted into kinetic energy. A change in momentum of said flowing liquid may be dependent on the descending angle (labelled as Φ) and other factors determining headloss pressure, such as a diameter of said inlet section (2), bends in pipes, and a pipe's material roughness. A configurable initiation valve (not shown but located at high elevation at installation (25) may be configured to repeatedly open according to a desired momentum (or dynamical pressure) of the flowing liquid, such that only a minimal amount of gravitational potential energy and kinetic energy of the flowing liquid is wasted.

In this embodiment, an energy generation mechanism, a heating mechanism and the initiation valve may be grouped together into a single unit or container (25), for example connected to the inlet section (2) and to the gas section (4). A location of the initiation valve mechanism in relation to the water inlet, length of the horizontal pipe following the steam exit (5), descending angle (labelled as Θ), diameter and length of the gas section (4) and other parameters of the system may be selected to achieve a required gas pressure and/or temperature, and, for example, to maximize the efficiency of the system in hot gas generation. The descending angle of the inlet section (Φ) and the descending angle of the gas section (Θ) may differ. The inlet section (2), the gas section (4) and terminal section (5) need not be straight and can somewhat accommodate for curvature in landscape, although such curvature may negatively impact the overall efficiency of the system. The formed water columns arranged inside said gas section (4) may be pushed downstream to the terminal section (5) and may exit said system through an opening of said terminal section (26), for example into a lower reservoir, river or a water distribution system. In this embodiment, the produced heated gas may be transported through an extraction pipeline (13) into a heated gas or steam storage container (27). In this embodiment, the heated gas storage container and/or the gas extraction pipeline (13) may comprise additional heating and/or pressurizing systems to achieve and maintain required steam properties. The produced heated gas may then be transferred through a distribution network (28) for industrial use (29) or to supply residential areas (30) with central heating. In an alternative embodiment, the heated gas may be brought directly from said gas extraction section and into such industrial applications or residential areas.

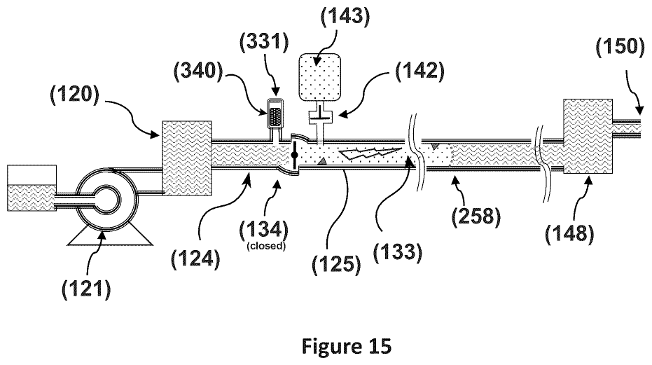

FIG. 15 illustrates another embodiment of a vapor or steam generation system according to the current disclosure. In the illustrated system of FIG. 15, a source of liquid (120) may comprise a highly pressurized liquid, such as provided by a pump or process inducing pressure in the liquid (121) as may be found within several chemical processes and in water treatment plants. In the depicted embodiment, the highly pressurized liquid may flow rapidly into said inlet section (124) until sufficient momentum of flowing liquid is obtained and said initiation valve (134) abruptly closes, initiating the evaporation and generation of the gas which is subsequently heated. In this embodiment, the pipes comprising the inlet section (124), gas section (125) and terminal section (150) may all be aligned in any slope configuration, such as a (approximately) horizontal fashion, and in pipes of varying length and diameter. In this embodiment the pressurized liquid used may be a byproduct of an industrial process.

In an embodiment, the initiation valve (134) may be configured to re-open when a pressure differential between an inlet section upstream (124) of the initiation valve (134) and the gas section (125) downstream of the initiation valve (134) is reduced to a predetermined limit. For some embodiments, the initiation valve (134) may be configured similar to an inverted weighted or stiffened non-return valve, meaning that it should only allow liquid to flow in the opposite direction, but because the valve is stiffened or otherwise configured it allows liquid to flow through it in the direction it is conventionally designed to stop, up until the dynamic pressure of the liquid reaches a certain limit when the valve closes.

In an embodiment, the initiation valve (134) may be configured to abruptly close when the velocity of the liquid reaches a certain limit.

While depicted as an upstream high-pressure liquid vessel (128), it is noted that one or more of a pressure chamber, a vessel, a delivery pipe, or the like may be provided in place of the upstream high-pressure liquid vessel (128). The relief valve (126) may be configured to open when a static pressure in said inlet section (124) increases above a pressure exerted on the relief valve (126) from a liquid arranged in the upstream high-pressure liquid vessel (128), such as from the abrupt closing of the initiation valve (134). In such an embodiment, the upstream high-pressure liquid vessel (128) may be connected to said relief valve (126), allowing a flow of liquid from the inlet section (124) and into the upstream high-pressure liquid vessel (128) when said relief valve (126) opens.

According to varying embodiments, the relief valve (126) may comprise a non-return valve conventionally oriented and configured to close when a pressure differential in front of the relief valve (126) (e.g., in the inlet section (124)) and behind the relief valve (126) (e.g., in the upstream high-pressure liquid vessel (128)) reaches a pre-determined limit. In other words, the relief valve (126) may open when the static pressure inside said inlet section (124) is enough to push said relief valve (126) open and/or when pressure spikes from the abrupt closing of the initiation valve (134) push the relief valve (126) open and suddenly closed due to the pressure (and weight of the relief valve (126)) exerted by the liquid inside the upstream high-pressure liquid vessel (128) pushing against the relief valve (126).

A weight (or stiffness) and a set of pressure limits of initiation valve (134) and the relief valve (126) may be configured and optimized along with other parameters of the system such that the two valves work together to maximize production of gas in repeated regular cycles from said flowing liquid. Accordingly, while the initiation valve (134) remains open, the relief valve (126) may remain closed and, when the initiation valve (134) closes, the relief valve (126) may open (sometimes repeatedly) allowing pressurized liquid to flow into the upstream high-pressure liquid vessel (128). In some embodiments, the initiation valve (134) and/or the relief valve (126) may be selected to be electronic valves used to regulate the flow of liquid through said valves according to factors such as, but not limited to, dynamic pressure, flow rate of liquid or elapsed time. An electronic control of said initiation valve (134) and/or said relief valve (126) may further comprise suitable sensors equipped to measure the aforementioned factors and/or a connection means to transmit data to an in-situ or remote-control unit for either a manual control or more preferably an automatic pre-programmed means of control.

To increase durability of the system and related devices according to various embodiments, a slug system, as depicted in FIG. 9 may be employed to mitigate the pressure waves and absorb the kinetic energy of the fast moving upper column of water. In other embodiments an upstream high-pressure liquid vessel (128) may be employed, which may contain air, gas or a compressible cushion as a dampener (130). In yet another embodiment, a dampener may be selected as an elastic diaphragm. A snifting valve may furthermore be used to maintain the dampener mechanism.

The upstream high-pressure liquid vessel (128) may be connected via a gas and/or liquid connector (155), as illustrated in FIG. 13, to the pressure mechanism in the liquid trap (148).

As liquid is added to the upstream high-pressure liquid vessel (128) and pressure within it increases, the dampener (130) may be compressed and, analogous to a compressed spring, the dampener (130) may begin to exert a force on the flowing liquid which serves to push the flowing liquid in the opposite direction of the flow, i.e., providing a counter-pressure. The counter-pressure may aid both in closing and keeping the relief valve (126) closed. A pressure of the fluid in the inlet section (124) and/or the upstream high-pressure liquid vessel (128), and partly the weight of the relief valve (126) itself, may force the relief valve (126) to shut again. Moreover, pressure waves may travel up to a water source connected to the inlet section (124), where the pressure waves may become dampened by ambient air and converted to a suction force (or a pulse) that may travel downstream through the inlet section (124) and aid in reducing a hydrostatic pressure in front of the closed initiation valve (134).

It should be noted that several Figures depict a liquid trap (148) in a horizontal section of the pipe (122), with the horizontal section (147) leading to the liquid trap (148) forming an angle with the gas section (125). In embodiments having such a horizontal section (147), the arrangement of the horizontal section (147) may advantageously increase an overall kinetic energy that the system harnesses both due to the available head-height and increasing mass of the moving lower column of liquid (127). In some embodiments, a substantially horizontal section (147), or at least in some embodiments more horizontal than the gas section, may further provide a counterbalance for compressing and directing the vapor (133) to an extraction valve (140b), such as in embodiments of the system which extract vapor by reopening the initiation valve (134) and allowing a flow of liquid from the inlet section (124) into the gas section (125) and pushing the vapor (133) against the lower liquid column (127). In one embodiment, the system may use the horizontal section (148) to increase the momentum of the lower liquid column (127) in traversing back into the gas section (125) Likewise, the angle formed by the horizontal section (147) with the gas section (125) may be configured for corresponding with other restraints or parameters, such as maximum height, to balance process parameters in the system, such as final temperature and pressure of the output steam.

Having the gas section (125) pipe positioned at an angle or vertically, further has the advantage of a smaller and better-defined surface area between the colder liquid of the lower liquid column and the low pressure vapor, which the heated vapor will interact with during the compression phase.

A liquid source (120) may be provided in various embodiments of the disclosure, such as depicted in FIG. 1. As seen in the illustrated embodiment, the liquid source (120) may be provided at a location of higher potential energy than said initiation valve (134). The pipe (122) may comprise a mechanical or electrical valve at or near the point of connection to the supply of liquid.

The inlet section (124) may be configured at a descending angle, wherein the flowing liquid is accelerated down said inlet section (124) due to gravity. Alternatively, the liquid source (120) may be selected as a supply of (highly) pressurized liquid in comparison to pressure at the liquid trap (148), wherein the momentum of flowing liquid through said inlet section (124) is then generated by the pressure difference between the liquid source (120) and the pressure in the liquid trap (148). For some embodiments having a pressurized liquid source, the inlet section (124) and gas section (125) may be aligned in any direction, such as horizontally aligned and the liquid source (120) does not need to be elevated compared to the initiation valve (134) and the liquid trap (148).

In an embodiment, the inlet section (124) and gas section (125) may be arranged at descending angle relative to the ground. In some embodiments the gas section (125) is furthermore connected to a liquid trap and a terminal section (150) which may be approximately parallel to the ground. Absolute and relative lengths of the conduit or pipe parts of the system can be chosen to achieve particular temperature, pressures, and/or efficiencies in the system. For example, if the initiation valve is located relatively low in the system, less steam may be produced but at higher temperature and pressure due to (a) higher compressive pressures required by the lower water column to reopen the initiation valve in the compression phase and/or (b) increased energy generated by abruptly stopping the mass of the relatively longer upper water column acting on the relatively smaller mass of evaporated vapor in the gas section (125).

As noted previously, in varying embodiments of the disclosure, heating means may be provided in the system for heating the vapor, the heating means comprising an ion wave, electrical spark or short duration arc and/or a burst of other electromagnetic waves, such as a microwave burst. Other heating means may include inductive heating, electrical heating, frictional heating, and/or vibrational heating. In some preferred embodiments, the heating phase may be configured to start at the beginning of the compression phase of the vapor.

In some embodiments, the energy used for the heating phase, may advantageously be generated by the kinetic energy and/or water hammer effect of the upper column of liquid in the inlet section.

In some embodiments, an electrical voltage amplifier may be employed to amplify or increase the frequency of the voltage generated by the piezoelectric or linear generators if required for energizing the vapor (133). Furthermore, an electrical circuit may be provided to delay or rectify the electrical pulse in order to configure the timing and magnitude of the ion wave, spark, short duration arc or energize other means of heating the low pressure vapor when it has been generated.

In some embodiments, liquid exiting the gas section may be returned to a liquid supply and/or to the inlet section of the system. For example, after extracting the vapor from the gas section, the liquid column may flow downstream before being pumped to the liquid supply or the inlet section, to be used again in generating additional vapor.

The current figures illustrate various embodiments of the disclosure including combinations of several features of the disclosure. As previously noted, other advantageous configurations are envisioned, and varying embodiments may include varying combinations of different features from the depicted embodiments.

As can be appreciated from the foregoing, in addition to alternative and/or additional embodiments provided herein, the devices, systems, and methods of the present disclosure can facilitate the generation of vapor or steam using kinetic and potential energy of a flowing liquid. In a simple embodiment, vapor or steam may be generated from a pipe system with only three to four fine-tuned moving parts, rendering the disclosed devices and systems both economical and highly durable.

Notably a large-scale embodiment of the device should be relatively impervious to floating debris, organic matter and sediments flowing through the system. This feature is in stark contrast to traditional turbine-generator systems that feed pressurized water through narrow nozzles directly at precision manufactured machinery rotating at high speeds where large, specialized structures and equipment is required to re-route and filter out debris and sediment.

Moreover, as various embodiments may not require any other sources of energy for operation besides a source of liquid, the described embodiments are economical, safe, and clean alternative to traditional means of producing heated gas or steam. In some embodiments, the disclosed devices, systems and methods may be used to additionally produce and harness electricity that can be used to augment some functions and/or components of the respective device or system, e.g., to power additional means of heating and/or sensors and/or a connection means to allow the operational status of the system to be transmitted for remote monitoring and/or control in real-time in situ or at a remote location and/or to provide lighting around the infrastructure, etc. In some embodiments, it may be economical to use an external energy source to heat the vapor sufficiently for it not to condense during pressurization, heating and extraction.

In one embodiment the system is configured to generate high temperature steam at relatively low pressures suitable for hydrogen generation.

The described devices, systems and methods have several advantages over existing boiler and hydropower technologies, including significantly lower costs than existing hydropower and/or boiler installations both in terms of initial- and operating costs. Unlike most other ways to create energy this system should not require mined “rare-earth” materials for its construction. The disclosed embodiments may employ conventional and readily available materials in a robust and sturdy system with no or minimal software or electrical vulnerabilities, increasing regional energy security. The disclosed embodiments are likewise safe for operators, consumers, and the environment, as they do not require the use of radioactive materials, toxic and/or combustible refrigerants, hydrocarbon fuels, or the like.

In one embodiment heated gas from a pressurized gas vessel (143) may be partially circulated into the gas section (125) during the vaporization process to augment and increase vapor temperature prior to pressurization and increase the volume of created vapor. Such a configuration (not shown), may generate a positive feedback-loop which can be used to balance increased temperature of the produced steam against a quantity that is extracted from the system.

Various alterations and/or modifications of the inventive features illustrated herein, and additional applications of the principles illustrated herein, which would occur to one skilled in the relevant art and having possession of this disclosure, can be made to the illustrated embodiments without departing from the spirit and scope of the invention as defined by the claims, and are to be considered within the scope of this disclosure. Thus, while various aspects and embodiments have been disclosed herein, other aspects and embodiments are contemplated. While a number of methods and components similar or equivalent to those described herein can be used to practice embodiments of the present disclosure, only certain components and methods are described herein.

It will also be appreciated that systems, devices, kits, methods, and/or processes, according to certain embodiments of the present disclosure may include, incorporate, or otherwise comprise properties, features (e.g., components, members, elements, parts, and/or portions) described in other embodiments disclosed and/or described herein. Accordingly, the various features of certain embodiments can be compatible with, combined with, included in, and/or incorporated into other embodiments of the present disclosure. Thus, disclosure of certain features relative to a specific embodiment of the present disclosure should not be construed as limiting application or inclusion of said features to the specific embodiment. Rather, it will be appreciated that other embodiments can also include said features, members, elements, parts, and/or portions without necessarily departing from the scope of the present disclosure.

Moreover, unless a feature is described as requiring another feature in combination therewith, any feature herein may be combined with any other feature of a same or different embodiment disclosed herein. Furthermore, various well-known aspects of illustrative systems, methods, apparatus, and the like are not described herein in particular detail in order to avoid obscuring aspects of the example embodiments. Such aspects are, however, also contemplated herein.

The skilled artisan will recognize the interchangeability of various disclosed features. Besides the variations described herein, other known equivalents for each feature can be mixed and matched by one of ordinary skill in this art to prepare a steam or vapor generation system and perform a method for utilizing the same under principles of the present disclosure. The skilled artisan will understand that the features described herein may be adapted to other types of liquids, industries, gases and energy applications generally.

The disclosure further relates to several embodiments as identified by the below numbered clauses. The present invention is in no way limited to the embodiments described by way of example and represented in the clauses, and the clauses are provided only to demonstrate non-limiting examples of possible embodiments.
1. A vapor generation system comprising: a conduit configured to receive a flowing liquid; an initiation valve provided in the conduit upstream from a gas section of the conduit; and an extraction valve provided at the gas section of the conduit; wherein the initiation valve is configured to abruptly close, leaving a lower liquid column in the gas section, the lower liquid column moving away from the closed initiation valve and generating a low pressure that partially vaporizes the liquid column into vapor, wherein the extraction valve is configured to extract the vapor.
2. The system according to any combination of one or more of clause 1 above and clauses 3-27 below, further comprising heating means configured to heat the vapor in the gas section of the conduit.
3. The system according to any combination of one or more of clauses 1-2 above and clauses 4-27 below, wherein the heating means comprises an antenna and/or electrode configured to electrically induce a fast ion wave, ion wave, plasma, spark or short duration arc in the vapor in the gas section of the conduit.
4. The system according to any combination of one or more of clauses 1-3 above and clauses 5-27 below, wherein the antenna and/or the electrode is provided inside the gas section of the conduit.
5. The system according to any combination of one or more of clauses 1-4 above and clauses 6-27 below, wherein the antenna and/or the electrode is provided outside the gas section of the conduit.
6. The system according to any combination of one or more of clauses 1-5 above and clauses 7-27 below, wherein the heating means comprises a collar electrode configured to electrically induce a fast ion wave, ion wave, plasma, spark or short duration arc in the vapor in the gas section of the conduit.
7. The system according to any combination of one or more of clauses 1-6 above and clauses 8-27 below, wherein the heating means comprises a laser configured to emit electromagnetic radiation into the vapor in the gas section of the conduit.
8. The system according to any combination of one or more of clauses 1-7 above and clauses 9-27 below, wherein the gas section further comprises conductive shielding for increasing the heating of the vapor in the gas section.
9. The system according to any combination of one or more of clauses 1-8 above and clauses 10-27 below, wherein the conductive shielding comprises a refractive material.
10. The system according to any combination of one or more of clauses 1-9 above and clauses 11-27 below, wherein the conductive shielding comprises a thermally insulating material.
11. The system according to any combination of one or more of clauses 1-10 above and clauses 12-27 below, further comprising an energy generating mechanism for converting a kinetic energy of the flowing liquid to electrical energy.
12. The system according to any combination of one or more of clauses 1-11 above and clauses 13-27 below, wherein the energy generating mechanism is provided at or upstream from the initiation valve.
13. The system according to any combination of one or more of clauses 1-12 above and clauses 14-27 below, wherein the energy generating mechanism comprises a piezoelectric material.
14. The system according to any combination of one or more of clauses 1-13 above and clauses 15-27 below, wherein an inlet section of the conduit upstream from the initiation valve comprises piezoelectric material for generating electrical energy from pressure fluctuations caused by closing the initiation valve.
15. The system according to any combination of one or more of clauses 1-14 above and clauses 16-27 below, wherein the initiation valve comprises piezoelectric material for generating electrical energy from pressure fluctuations caused by closing the initiation valve; and/or wherein the initiation valve comprises a curved valve disk configured to deflect the flowing liquid, such as into an energy generation mechanism.
16. The system according to any combination of one or more of clauses 1-15 above and clauses 17-27 below, wherein the energy generating mechanism comprises a slug element and a slug stopper connected to the conduit upstream from the initiation valve, wherein one or both of the slug element and the slug stopper comprises a piezoelectric material, such that closing the initiation valve causes the flowing liquid to accelerate the slug element against the slug stopper and deform the piezoelectric material to generate electrical energy.
17. The system according to any combination of one or more of clauses 1-16 above and clauses 18-27 below, wherein the energy generating mechanism comprises a magnetic linear generator connected to the conduit upstream from the initiation valve, such that closing the initiation valve causes an actuator of the magnetic linear generator to move in a magnetic field to generate electrical energy.
18. The system according to any combination of one or more of clauses 1-17 above and clauses 19-27 below, wherein the initiation valve is configured to open and close in a repeated manner in response to a predetermined parameter of the liquid and/or at a predetermined interval.
19. The system according to any combination of one or more of clauses 1-18 above and clauses 20-27 below, wherein the extraction valve is configured to only allow pressurized and heated gas to exit the gas section of the conduit, while preventing liquid from exiting the gas section of the conduit and/or preventing the extracted vapor from reentering the gas section of the conduit.
20. The system according to any combination of one or more of clauses 1-19 above and clauses 21-27 below, further comprising an upstream high-pressure liquid vessel connected to the conduit through a relief valve upstream from the initiation valve, wherein the relief valve is configured to open and allow pressurized liquid to enter the upstream high-pressure liquid vessel following the closing of the initiation valve.
21. The system according to any combination of one or more of clauses 1-20 above and clauses 22-27 below, wherein a liquid trap is arranged downstream from the gas section of the conduit.
22. The system according to any combination of one or more of clauses 1-21 above and clauses 23-27 below, wherein the flowing liquid is accelerated due to a supply of liquid being of higher pressure than pressure at the liquid trap.
23. The system according to any combination of one or more of clauses 1-22 above and clauses 24-27 below, further comprising a pressurization system connected to a lower part of the system in a region in proximity to a liquid trap which is arranged to increase pressure below the lower liquid column for compressing the vapor in the gas section of the conduit.
24. The system according to any combination of one or more of clauses 1-23 above and clauses 25-27 below, further comprising a downstream valve configured to prevent and/or slow down the liquid column in traveling in a direction of the initiation valve to allow for gases to be separated from the lower liquid column.
25. The system according to any combination of one or more of clauses 1-24 above and clauses 26-27 below, wherein the gas section of the conduit is arranged at a descending angle, allowing the flowing liquid to accelerate and flow through said gas section in response to gravitational force.
26. The system according to any combination of one or more of clauses 1-25 above and clause 27 below, wherein the extraction valve is arranged to remove the vapor after the vapor is heated and compressed in the gas section.
27. The system according to any combination of one or more of clauses 1-26 above, wherein the extraction valve comprises a one-way valve and a float valve configured to extract the vapor from the gas section while preventing liquid from exiting the system and/or preventing the pressurized vapor from reentering the conduit.
28. A method for generating vapor, the method comprising: providing a flowing liquid to a conduit, the flowing liquid passing through an initiation valve in the conduit and into a gas section of the conduit; abruptly closing the initiation valve, leaving a liquid column in the gas section, such that the liquid column moves away from the initiation valve and generates a low pressure in the gas section that partially vaporizes the liquid column into a vapor; and extracting the vapor from the gas section of the conduit using an extraction valve.
29. The method according to any combination of one or more of clause 28 above and clauses 30-56 below, further comprising heating the vapor in the gas section before extracting the vapor.
30. The method according to any combination of one or more of clauses 28-29 above and clauses 31-56 below, wherein said heating the vapor in the gas section comprises electrically inducing a fast ion wave, ion wave, plasma, spark or short duration arc in the vapor in the gas section of the conduit.
31. The method according to any combination of one or more of clauses 28-30 above and clauses 32-56 below, wherein the heating step is performed using an antenna and/or electrode configured to electrically induce a fast ion wave, ion wave, plasma, spark or short duration arc in the vapor in the gas section of the conduit.
32. The method according to any combination of one or more of clauses 28-31 above and clauses 33-56 below, wherein the antenna and/or the electrode is provided inside the gas section of the conduit.
33. The method according to any combination of one or more of clauses 28-32 above and clauses 34-56 below, wherein the antenna and/or the electrode is provided outside the gas section of the conduit.
34. The method according to any combination of one or more of clauses 28-33 above and clauses 35-56 below, wherein the heating step is performed using a collar electrode configured to electrically induce a fast ion wave, ion wave, plasma, spark or short duration arc in the vapor in the gas section of the conduit.
35. The method according to any combination of one or more of clauses 28-34 above and clauses 36-56 below, wherein said heating the vapor in the gas section comprises heating the vapor using electromagnetic radiation.
36. The method according to any combination of one or more of clauses 28-35 above and clauses 37-56 below, wherein the heating step is performed using a laser configured to emit electromagnetic radiation into the vapor in the gas section of the conduit.
37. The method according to any combination of one or more of clauses 28-36 above and clauses 38-56 below, wherein the gas section further comprises conductive shielding for increasing the heating of the vapor in the gas section.
38. The method according to any combination of one or more of clauses 28-37 above and clauses 39-56 below, wherein the conductive shielding comprises a refractive material.
39. The method according to any combination of one or more of clauses 28-38 above and clauses 40-56 below, wherein the conductive shielding comprises a thermally insulating material.
40. The method according to any combination of one or more of clauses 28-39 above and clauses 41-56 below, further comprising compressing the vapor in the gas section before extracting the vapor, by the liquid column moving back towards the initiation valve, wherein said compressing the vapor further increases a temperature and pressure of the vapor.
41. The method according to any combination of one or more of clauses 28-40 above and clauses 42-56 below, further comprising generating an electrical energy from a kinetic energy of the flowing liquid upstream from the initiation valve when the initiation valve is closed.
42. The method according to any combination of one or more of clauses 28-41 above and clauses 43-56 below, wherein the step of generating an electrical energy is performed using a piezoelectric material.
43. The method according to any combination of one or more of clauses 28-42 above and clauses 44-56 below, wherein an inlet section of the conduit upstream from the initiation valve comprises piezoelectric material for generating electrical energy from pressure fluctuations caused by closing the initiation valve.
44. The method according to any combination of one or more of clauses 28-43 above and clauses 45-56 below, wherein the initiation valve comprises piezoelectric material for generating electrical energy from pressure fluctuations caused by closing the initiation valve.
45. The method according to any combination of one or more of clauses 28-44 above and clauses 46-56 below, wherein the step of generating an electrical energy comprises providing a slug element and a slug stopper connected to the conduit upstream from the initiation valve, wherein one or both of the slug element and the slug stopper comprises a piezoelectric material, and, when the initiation valve is closed, causing the flowing liquid to accelerate the slug element against the slug stopper and deform the piezoelectric material to generate electrical energy.
46. The method according to any combination of one or more of clauses 28-45 above and clauses 47-56 below, wherein the step of generating an electrical energy comprises providing a magnetic linear generator connected to the conduit upstream from the initiation valve, and, when the initiation valve is closed, causing the flowing liquid to move an actuator of the magnetic linear generator in a magnetic field to generate electrical energy.
47. The method according to any combination of one or more of clauses 28-46 above and clauses 48-56 below, further comprising opening and closing the initiation valve in a repeated manner in response to a predetermined parameter of the liquid and/or at a predetermined interval.
48. The method according to any combination of one or more of clauses 28-47 above and clauses 49-56 below, wherein the extraction valve is configured to only allow pressurized and heated gas to exit the gas section of the conduit, while preventing liquid from exiting the gas section of the conduit and/or preventing the extracted vapor from reentering the gas section of the conduit.
49. The method according to any combination of one or more of clauses 28-48 above and clauses 50-56 below, further comprising an upstream high-pressure liquid vessel connected to the conduit through a relief valve upstream from the initiation valve, wherein the relief valve is configured to open and allow pressurized liquid to enter the upstream high-pressure liquid vessel following the closing of the initiation valve.
50. The method according to any combination of one or more of clauses 28-49 above and clauses 51-56 below, wherein a liquid trap is arranged downstream from the gas section of the conduit.
51. The method according to any combination of one or more of clauses 28-50 above and clauses 52-56 below, wherein the flowing liquid is accelerated due to a supply of liquid being of higher pressure than pressure at the liquid trap.
52. The method according to any combination of one or more of clauses 28-51 above and clauses 53-56 below, further comprising increasing a pressure below the lower liquid column and compressing the vapor in the gas section of the conduit using a pressurization system connected to a lower part of the system in a region in proximity to a liquid trap.
53. The method according to any combination of one or more of clauses 28-52 above and clauses 54-56 below, further comprising separating gases from the lower liquid column by preventing and/or slowing down the liquid column in traveling in a direction of the initiation valve using a downstream valve in the conduit downstream from the gas section.
54. The method according to any combination of one or more of clauses 28-53 above and clauses 55-56 below, wherein the gas section of the conduit is arranged at a descending angle, allowing the flowing liquid to accelerate and flow through said gas section in response to gravitational force.
55. The method according to any combination of one or more of clauses 28-54 above and clause 56 below, wherein the extraction valve is arranged to remove the vapor after the vapor is heated and compressed in the gas section.
56. The method according to any combination of one or more of clauses 28-55 above, wherein the extraction valve comprises a one-way valve and a float valve configured to extract the vapor from the gas section while preventing liquid from exiting the system and/or preventing the pressurized vapor from reentering the conduit.

What is claimed is:

1. A vapor generation system comprising:
a conduit configured to receive a flowing liquid,
an initiation valve provided in the conduit upstream from a gas section of the conduit, and
an extraction valve provided at the gas section of the conduit,
wherein the initiation valve is configured to abruptly close, leaving a lower liquid column in the gas section, the lower liquid column moving away from the closed initiation valve and generating a low pressure that partially vaporizes the liquid column into vapor,
wherein the extraction valve is configured to extract the vapor.

2. The system according to claim 1, further comprising heating means configured to heat the vapor in the gas section of the conduit.

3. The system according to claim 2, wherein the heating means is configured to transfer electromagnetic energy to the vapor in the gas section of the conduit.

4. The system according to claim 1, further comprising an energy generating mechanism for converting a kinetic energy of the flowing liquid upstream from the initiation valve to electrical energy when the initiation valve is closed.

5. The system according to claim 4, wherein the energy generation mechanism comprises a piezoelectric material.

6. The system according to claim 1, wherein the initiation valve is configured to open and close in a repeated manner in response to a predetermined parameter of the liquid and/or at a predetermined interval.

7. The system according to claim 1, wherein the extraction valve is configured to only allow pressurized and heated gas to exit the gas section of the conduit, while preventing liquid from exiting the gas section of the conduit and/or preventing the extracted vapor from reentering the gas section of the conduit.

8. The system according to claim 1, further comprising an upstream high-pressure liquid vessel connected to the conduit through a relief valve upstream from the initiation valve, wherein the relief valve is configured to open and allow pressurized liquid to enter the upstream high-pressure liquid vessel following the closing of the initiation valve.

9. The system according to claim 1, wherein a liquid trap is arranged downstream from the gas section of the conduit.

10. The system according to claim 8, wherein the liquid is accelerated due to a supply of liquid being of higher pressure than pressure at the liquid trap.

11. The system according to claim 1, further comprising a pressurization system connected to a lower part of the system in a region in proximity to a liquid trap which is arranged to increase pressure below the lower liquid column for compressing the vapor in the gas section of the conduit.

12. The system according to claim 1, further comprising a downstream valve configured to prevent and/or slow down the liquid column in traveling in a direction of the initiation valve to allow for gases to be separated from the lower liquid column.

13. The system according to claim 1, wherein the gas section of the conduit is arranged at a descending angle, allowing liquid to accelerate and flow through said section in response to gravitational force.

14. The system according to claim 1, wherein the extraction valve is arranged to remove the vapor after the vapor is heated and compressed in the gas section.

15. A method for generating vapor, the method comprising:
providing a flowing liquid to a conduit, the flowing liquid passing through an initiation valve in the conduit and into a gas section of the conduit;
abruptly closing the initiation valve, leaving a liquid column in the gas section, such that the liquid column moves away from the initiation valve and generates a low pressure in the gas section that partially vaporizes the liquid column into a vapor; and
extracting the vapor from the gas section of the conduit using an extraction valve.

16. The method according to claim 15, further comprising heating the vapor in the gas section before extracting the vapor.

17. The method according to claim 16, wherein the step of heating the vapor is performed using electromagnetic radiation.

18. The method according to claim 15, further comprising generating an electrical energy from a kinetic energy of the flowing liquid upstream from the initiation valve when the initiation valve is closed.

19. The method according to claim 18, wherein the step of generating the electrical energy is performed using a piezoelectric material.

20. The method according to claim 15, further comprising compressing the vapor in the gas section before extracting the vapor, by the liquid column moving back towards the initiation valve, wherein said compressing the vapor further increases a temperature and pressure of the vapor.
